(19) United States
(12) Patent Application Publication
(10) Pub. No.: US 2026/0222779 A1
(43) Pub. Date: Jul. 30, 2026

(54) CONFEDERATION OF NETWORKS (CONET) MANAGEMENT FOR MULTIPLE PLAYERS

(71) Applicant: Huawei Technologies Co., Ltd., Shenzhen (CN)

(72) Inventors: Wei Tan, Shanghai (CN); Hang Zhang, Ottawa (CA)

(21) Appl. No.: 19/631,087

(22) Filed: Mar. 27, 2026

Related U.S. Application Data
(63) Continuation of application No. PCT/CN2024/082198, filed on Mar. 18, 2024.
(60) Provisional application No. 63/586,603, filed on Sep. 29, 2023.

(51) Int. Cl. H04W 4/50; H04W 64/00

(52) U.S. Cl. CPC H04W 4/50; H04W 64/00

(57) ABSTRACT

Example embodiments relate to methods, systems and apparatuses t for action surveillance for multiple players. A first function, such as an SCF, receives a first request for an initialization for uploading action logs to a blockchain. The first function (such as an SCF) determines parameters for uploading action logs to the blockchain, and thus the parameters can be used by the XaaS entity for uploading the action logs. The parameters include a first set of interval parameters and a second set of grouping parameters, this allows for the uploading of action logs to be done accordingly, avoiding individual uploads for each action log and reducing overhead.

### CROSS-REFERENCE TO RELATED APPLICATIONS

This application is a continuation of International Patent Application No. PCT/CN2024/082198, filed on Mar. 18, 2024, which claims the benefits of U.S. Provisional Application No. 63/586,603, filed on Sep. 29, 2023, the disclosures of which are hereby incorporated by reference in their entireties.

### TECHNICAL FIELD

Example embodiments of the present disclosure relate generally to the field of communications including a radio access network (RAN) and a core network (CN), and in particular, to confederation network (CONET) management for multiple players.

### BACKGROUND

Current wireless communication systems (also referred to as wireless systems), such as 5th Generation (5G) systems defined by the 3rd Generation Partnership Project (3GPP), are designed to provide connectivity services. It is anticipated that future wireless systems (e.g. 6th Generation (6G) systems defined by the 3GPP) will go beyond connectivity provisioning to offer various new services, such as artificial intelligence and data management services. It is also anticipated the future wireless system may be operated by multiple parties, for example with different parties operating a different portion of the wireless system to offer certain services. These services may be provided for the system's (e.g. operating party's) internal use or for an end customer's use. The different parties, such as telecommunication operators and vertical service providers, may have their own interests and agendas, which may potentially compete or conflict with the interests and agendas of others.

### SUMMARY

In general, example embodiments of the present disclosure provide a solution for managing overhead for multiple players.

In a first aspect, there is provided a method performed by a first function. The method comprises: receiving, from a second function associated with an anything as a service (XaaS) service, a first request for an initialization for uploading action logs to a blockchain; determining a plurality of parameters for the initialization based on the first request, wherein the plurality of parameters may comprise a first set of interval parameters and a second set of grouping parameters; and transmitting, to the second function, a first response comprising the plurality of parameters. As such, the first function (such as a surveillance control function (SCF)) determines parameters for uploading action logs to the blockchain, and thus the parameters can be used by the XaaS entity for uploading the action logs. The parameters include a first set of interval parameters and a second set of grouping parameters, this allows for the uploading of action logs to be done accordingly, avoiding individual uploads for each action log and reducing overhead. Therefore, a management of overhead for multi players in the system is enabled, and the system can be scalable and credible for multiple players to work together.

In some example embodiments, the first set of interval parameters comprises at least one of: a first interval for a network function of the XaaS service to push the action logs to the second function, a second interval for the second function to pull the action logs from the network function, or a third interval for the second function to upload the action logs to the blockchain. As such, the parameters include the first set of interval parameters which may be used for pushing or pulling action logs, this allows for simultaneous pushing or pulling of multiple action logs during a single operation, consequently reducing overhead.

In some example embodiments, the first set of interval parameters further comprises at least one of: a timeout interval for the second function pulling action logs from the network function, or a repeat interval for uploading. As such, the parameters further include a timeout interval and/or a repeat interval, enabling a trade-off between overhead and efficiency, thereby enhancing system performance.

In some example embodiments, the second set of grouping parameters comprises at least one of: a first grouping interval for a smallest interval of any two logs in a same group, a second grouping interval for a longest interval of any two logs in a same group, or one or more parameters for grouping. As such, the parameters include grouping parameters, allowing multiple action logs to be grouped together for uploading, avoiding individual uploads for each action log, and reducing overhead.

In some example embodiments, the method further comprises: determining at least one parameter used by the first function, wherein the at least one parameter comprises a surveillance interval for triggering of uploading the action logs. As such, the at least one parameter such as a surveillance interval can be further determined, which may be used by the SCF to trigger the uploading of action logs, thus the action surveillance at the SCF is enabled, and accordingly the system can be scalable and credible for multiple players to work together.

In some example embodiments, the method further comprises: determining a management mode for the initialization; and transmitting, to the second function, an indication of the management mode, wherein the management mode comprises one of: an on-demand mode, a periodical mode, a threshold mode, or a poll based mode. As such, a management mode can be determined for uploading action logs, various scenarios can be considered, thus different management modes can be applied based on the scenario, showcasing system flexibility.

In some example embodiments, the method further comprises: determining an interaction method for the action logs; and transmitting, to the second function, an indication of the interaction method, wherein the interaction method comprises a synchronous method or an asynchronous method. As such, an interaction method can be determined for uploading action logs, the asynchronous method may be utilized in some cases, the action logs to be uploaded can be cached for a while, thereby reducing overhead.

In some example embodiments, the method further comprises: receiving, from the second function, a second request for uploading the action logs; and transmitting, to the second function, a second response comprising location information of a chain on the blockchain. As such, the action logs can be uploaded to the chain based on the second response, since the parameters can be used while uploading, the overhead can be reduced and the system performance is enhanced.

In a second aspect, there is provided a method performed by a second function associated with an XaaS service. The method comprises: transmitting, to a first function, a first request for an initialization for uploading action logs to a blockchain; and receiving, from the first function, a first response comprising a plurality of parameters for the initialization, wherein the plurality of parameters may comprise a first set of interval parameters and a second set of grouping parameters.

In some example embodiments, the first set of interval parameters comprises at least one of: a first interval for a network function of the XaaS service to push the action logs to the second function, a second interval for the second function to pull the action logs from the network function, or a third interval for the second function to upload the action logs to the blockchain.

In some example embodiments, the first set of interval parameters further comprises at least one of: a timeout interval for the second function pulling action logs from the network function, or a repeat interval for uploading.

In some example embodiments, the second set of grouping parameters comprises at least one of: a first grouping interval for a smallest interval of any two logs in a same group, a second grouping interval for a longest interval of any two logs in a same group, or one or more parameters for grouping.

In some example embodiments, the method further comprises: receiving, from the first function, an indication of a management mode for the initialization, wherein the management mode comprises one of: an on-demand mode, a periodical mode, a threshold mode, or a poll based mode.

In some example embodiments, the method further comprises: receiving, from the first function, an indication of an interaction method for the action logs, wherein the interaction method comprises a synchronous method or an asynchronous method.

In some example embodiments, the method further comprises: transmitting, to the first function, a second request for uploading the action logs; and receiving, from the first function, a second response comprising location information of a chain on the blockchain.

In some example embodiments, the method further comprises: determining a group of action logs based on the second set of grouping parameters; and uploading the group of action logs to the chain on the blockchain based on the first set of interval parameters. As such, action logs can be combined into a group based on the grouping parameters and be uploaded based on the interval parameters, avoiding individual uploads for each action log and reducing overhead.

In some example embodiments, the method further comprises: in accordance with a determination that an interaction method is an asynchronous method, caching the action logs at the second function; and in accordance with a transfer condition is met, transmitting the at least one group of action logs to the blockchain. As such, in case the asynchronous method is utilized, the action logs to be uploaded can be cached for a while, thereby reducing overhead.

It is to be understood that the technical effects discussed with reference to the first aspect above may also to applied to various embodiments of the second aspect, which will not be repeated herein for brevity.

In a third aspect, there is provided an apparatus. The apparatus comprises: a receiving module configured to receive, from a second function associated with an XaaS service, a first request for an initialization for uploading action logs to a blockchain; a processing module configured to determine a plurality of parameters for the initialization based on the first request, wherein the plurality of parameters may comprise a first set of interval parameters and a second set of grouping parameters; and a transmitting module configured to transmit, to the second function, a first response comprising the plurality of parameters. The apparatus may comprise respective modules for implementing the methods in the first aspect, for ease of brevity, the detailed description will not be listed herein.

In a fourth aspect, there is provided an apparatus. The apparatus comprises: a transmitting module configured to transmit, to a first apparatus, a first request for an initialization for uploading action logs to a blockchain; and a receiving module configured to receive, from the first function, a first response comprising a plurality of parameters for the initialization, wherein the plurality of parameters may comprise a first set of interval parameters and a second set of grouping parameters. The apparatus may comprise respective modules for implementing the methods in the second aspect, for ease of brevity, the detailed description will not be listed herein.

In a fifth aspect, there is provided a method, comprising: transmitting, by a second function associated with an XaaS service to a first function, a first request for an initialization for uploading action logs to a blockchain; receiving, by the first function, the first request from the second function; determining, by the first function, a plurality of parameters for the initialization based on the first request, wherein the plurality of parameters may comprise a first set of interval parameters and a second set of grouping parameters; transmitting, by the first function to the second function, a first response comprising the plurality of parameters; and receiving, by the second function, the first response from the first function.

In a sixth aspect, there is provided a communication device, comprising: a processor configured to perform, with a transceiver, at least the method in the first aspect.

In a seventh aspect, there is provided a communication device, comprising: a processor configured to perform, with a transceiver, at least the method in the second aspect.

In an eighth aspect, there is provided a system, comprising: an apparatus in the third aspect and an apparatus in the fourth aspect. The system may be configured to implement the method in the fifth aspect.

In a ninth aspect, there is provided a non-transitory computer readable medium having program instructions stored thereon, for causing an apparatus to perform at least the method in the first or second aspect.

In a tenth aspect, there is provided a computer program comprising instructions, which, when executed by an apparatus, cause the apparatus at least to perform the method in the first or second aspect.

It is to be noted that the technical effects of the first aspect of the embodiments of the first aspect are also applied for each of the second aspect to the tenth aspect, thus the technical effects for the second to tenth aspects will not be redundantly described herein.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates a simplified schematic illustration of a communication system in accordance with some example embodiments of the present disclosure;

FIG. 2 illustrates units or modules in a device in accordance with some example embodiments of the present disclosure;

FIG. 3 illustrates the 6G system conceptual structure in accordance with some example embodiments of the present disclosure;

FIG. 4 illustrates an example CONET architecture in which some example embodiments of the present disclosure may be implemented;

FIG. 5A illustrates an example framework of elements related to CONET in accordance with some example embodiments of the present disclosure;

FIG. 5B illustrates a framework of main elements related to CONET in accordance with some example embodiments of the present disclosure;

FIG. 6 illustrates an example process in accordance with some embodiments of the present disclosure;

FIG. 7A illustrates an example of parameters for initialization in accordance with some embodiments of the present disclosure;

FIG. 7B illustrates another example of parameters for initialization in accordance with some embodiments of the present disclosure;

FIG. 7C illustrates a further example of parameters for initialization in accordance with some embodiments of the present disclosure;

FIG. 8 illustrates an action initialization process in accordance with some embodiments of the present disclosure;

FIG. 9 illustrates an example process for uploading in accordance with some embodiments of the present disclosure;

FIG. 10 illustrates a flowchart of an example method implemented at a first function in accordance with some embodiments of the present disclosure;

FIG. 11 illustrates a flowchart of an example method implemented at a second function in accordance with some embodiments of the present disclosure;

FIG. 12 illustrates a simplified block diagram of an apparatus according to some example embodiments of the present disclosure;

FIG. 13 illustrates a simplified block diagram of an apparatus according to some example embodiments of the present disclosure; and

FIG. 14 illustrates an example block diagram of a device that may be used to implement some embodiments of the present disclosure.

Throughout the drawings, the same or similar reference numerals represent the same or similar elements.

### DETAILED DESCRIPTION OF THE ILLUSTRATIVE EMBODIMENTS

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “anything as a service (XaaS)” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe for example that the functionality of an arbitrary module disclosed herein can be provided as a service to another module or an external entity, such as a customer. The phrase “as service” is used herein to be synonymous with “as a service.”

An open system architecture may refer to a design approach in which systems (e.g. modules) are interoperable and inter-connectable with one another, generally without requiring retrofit or redesign. An open system architecture is one approach for achieving a modular design in which modules are configured to be interoperable. An open system architecture can involve modules which are responsive in a known manner to known inputs, for example to perform actions or provide responses to queries, inputs or stimuli in a predictable (possibly standardized) manner. Modules in an open system architecture can provide functionalities as a service in that they respond to inputs or stimuli in a particular way, thus providing such functionalities. A service may be provided by a server to a client, and thus the “as service” model may involve a server-client model.

An open system architecture may be used to provide any one or more of a variety of services, centric to any one of a variety of entities such as providers or users, to support various operating scenarios. The architecture may further provide for a scalable system, allowing for dynamically enabling or delivering a variety of currently known and to-be-determined services without necessarily modifying or redesigning the overall system architecture.

Many new trends will trigger the consideration and design of 6G or future wireless networks:
New network infrastructure capability, e.g., cloud natured/friendly infrastructures that are broadly deployed.
New (relative) matured techniques, e.g., artificial intelligence (AI) large scale models, Data de-privacy, Block chain, etc. that have made significant progresses and significantly impact on the entire society and human life.
New apps and services, e.g., AI services, Data (sensing) service, Digital world service, etc. that are broadly applied in industry/business and used by individual customers.
More global/open/collaborative operation trend, i.e., a more open and more collaborative operation mode are becoming common practice in many fields.

New expectation and stricter requirements on future networks also drive rethinking and development of new generation of wireless networks. These requirements include: privacy and trustworthiness, simplified standardization, rapid deployment, etc. All of the above drives 6G network architecture research work.

The proposed 6G network architecture may following key design principles of 6G system: service based architecture, and/or cloud-native infrastructures (network virtualization). Some requirements to 6G system network architecture design are listed as examples. For example, the proposed 6G network architecture needs to support new 6G services which could be developed/deployed by 3rd parties. For example, the proposed 6G network architecture needs to embrace more open ecosystem to open door to technical capable 3rd parties. For example, the proposed 6G network architecture needs to enable better trustworthiness management. In this event, a solution to enable above requirements is needed.

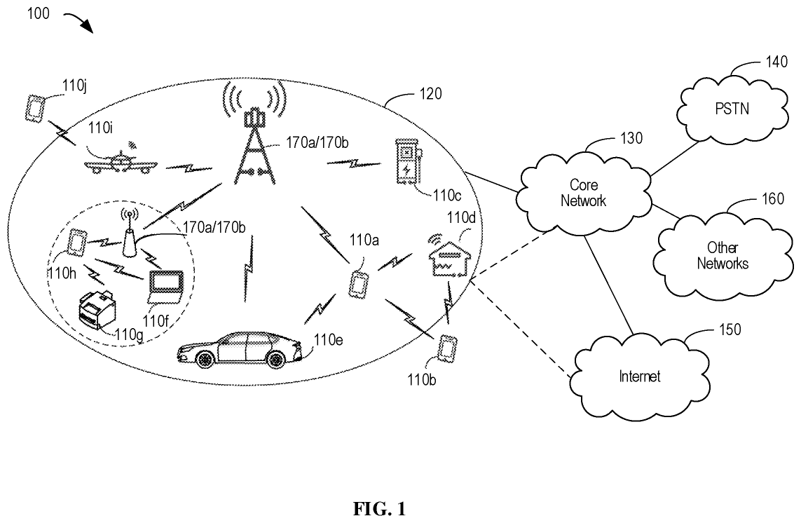

Referring to FIG. 1, as an illustrative example without limitation, a simplified schematic illustration of a communication system 100 is provided. The communication system 100 comprises a radio access network 120. The radio access network 120 may be a next generation (e.g. 6G or later) radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system 100 and may be dependent or independent of the radio access technology used in the communication system 100. Also the communication system 100 comprises a public switched telephone network (PSTN) 140, the internet 150, and other networks 160.

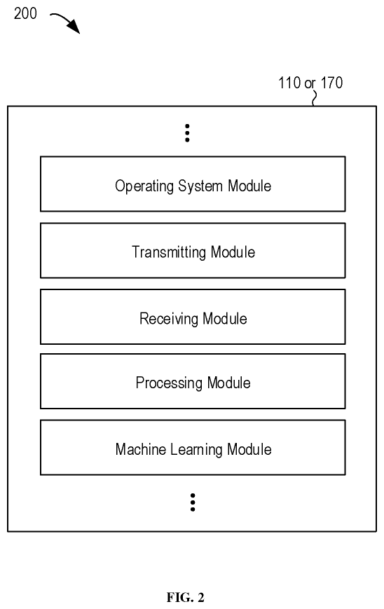

One or more steps of the embodiment methods provided herein may be performed by corresponding units or modules, according to FIG. 2. FIG. 2 illustrates units or modules in a device 200, such as in an ED no or a network node 170. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit, such as a programmed field-programmable gate array (FPGA), a graphics processing unit (GPU), or an application specific integrated circuit (ASIC). It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

The solution described in the present disclosure is applicable to a next generation (e.g. 6G or later) network, or a legacy (e.g. 5G, 4G, 3G or 2G) network. The proposed 6G system architecture is defined to support 6G XaaS services by using techniques such as Network Function Virtualization and Network Slicing. The 6G system architecture utilizes service-based interactions between 6G services.

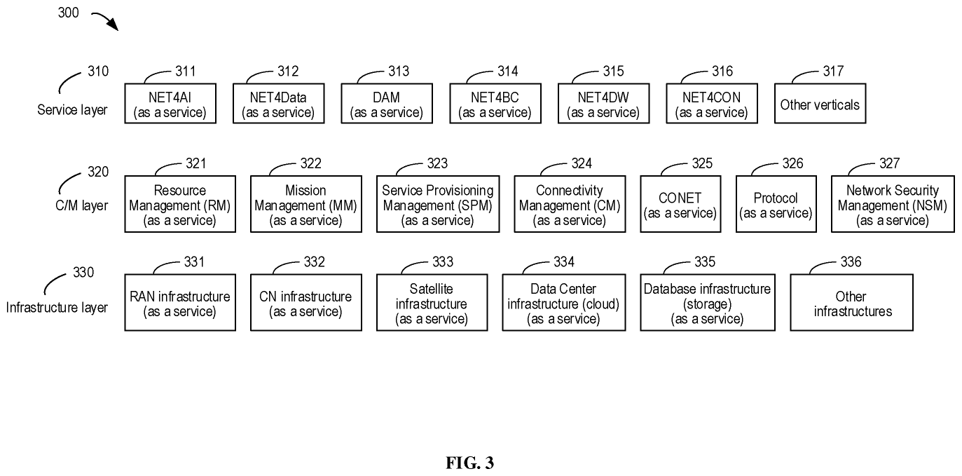

The 6G system leverages service-based architecture and XaaS concept, where XaaS services in the 6G system are categorized into three layers. FIG. 3 illustrates the 6G system conceptual structure 300 including a service layer 310, a control and management (C/M) layer 320, and an infrastructure layer 330.

Infrastructure layer 330 includes infrastructures supporting 6G services. Among them are RAN infrastructure 331, CN infrastructure 332, satellite infrastructure 333, data center infrastructure 334, database infrastructure 335, and other infrastructures 336. For example, the RAN infrastructure 331 and the CN infrastructure 332 together may refer to wireless networks infrastructures, the data center infrastructure 334 may refer to a cloud infrastructure, the database infrastructure 335 may refer to a storage infrastructure, and other infrastructures 336 may include sensing networks, etc. These infrastructures can be provided by a single provider or by multiple providers.

Each of the infrastructures could have its control and management functions, denoted as C/M functions, for infrastructure management. Each of these infrastructures is one type of Infrastructure as a Service.

C/M layer 320 includes control and management services of the 6G system. They are developed and deployed by using slicing techniques and utilizing resource provided by the infrastructure layer 330. 6G services in the C/M layer 320 include: resource management (RM) 321 as a service, mission management (MM) 322 as a service, service provisioning management (SPM) 323 as a service, connectivity management (CM) 324 as a service, COnfederation NETwork (CONET) 325 as a service, protocol 326 as a service, and network security management (NSM) 327 as a service. For purposes of this disclosure, the term “CONET” may also be referred to as CONsortium of NETworks.

Resource management 321 as a service provides a capability of life-cycle management of a variety of slices and over-the-air resource assignment to wireless devices.

A 6G mission is defined as a service provided to customers by the 6G system. A mission can be a type of services which is provided by a single 6G XaaS service or a type of services that needs contributions from multiple XaaS services. Mission management 322 as a service provides a capability to program provisioning of XaaS services at service layer 310 to provide mission services.

Service provisioning management 323 as a service provides a capability of control and management of 6G service access by customers and provisioning of requested services. The capability is provided by unified mutual authentication, authorization and policy, key management, quality of service (QoS) assurance and charging between any pair of XaaS service provider and customer. The customers include end-customers not only in physical world, but also digital representatives in digital world.

Connectivity management 324 as a service leverages 5G connectivity management functions, but with extension to include digital world.

Confederation network 325 as a service provides a capability to enable multiple partners jointly provide 6G services. This capability is provided by confederation formation, mutual authentication, mutual authorization among partners and negotiation of agreement on recording and retracing of selected actions performed by partners, in order to assure a trustworthy environment of 6G system operations.

Protocol 326 as a service provides a capability to design service customized protocol stacks for identified interfaces. The protocol stacks could be pre-defined for on-demand selection, or could be on-demand designed.

Network security management 327 as a service provides a capability for owners of infrastructures to detect potential security risks of their infrastructures.

XaaS services in the C/M layer 320 support control and management of the 6G system itself and also provide support to verticals if requested. One example is that RM service can serve RAN for over-the-air resource management and can also provide service to a vertical for the vertical's over-the-air resource allocation to its end-customers. The XaaS in C/M layer 320 can be deployed by using slicing technique.

Service layer 310 includes 6G services which provide services to customers. In the 6G system conceptual structure, a network for AI (NET4AI) 311 as a service, a network for data (NET4Data) 312 as a service, a data analytics and management (DAM) 313 as a service, a network for blockchain (NET4BC) 314 as a service, a network for digital world (NET4DW) 315 as a service, a network for connectivity (NET4CON) 316 as a service, and other verticals 317 are shown in FIG. 3.

AI service is denoted as NET4AI 311 as a service. AI service provides AI capability to support a variety of AI applications.

Service of storage and sharing of data is denoted as NET4Data 312 as a service, this service provides a capability to trustworthily storage and share data under the control of owners of data and following recognized authorities' regulations on control of identified data.

Service of data collection, data sanitization, data analysis and data delivery are denoted as DAM 313 as a service, this service provides a capability of lifecycle management of statistic data, including acquisition, de-privatization, analysis and delivery of data which are information statistic data from any types of sensors, devices, network functions, and etc.

The 6G block chain service is denoted as NET4BC 314 as a service. This service provides a capability to support 6G block chain services.

Service to provide digital world is denoted as NET4DW 315 as a service, digital world service provides a capability to construct, control and manage digital world. Digital world is defined as digital realization of physical world.

Enhanced connectivity service, e.g., NET4CON 316 as a service, provides a capability to support exchange of messages and data among new 6G services.

All XaaS services at the service layer 310 are developed and deployed by using resource provided in infrastructure and utilizing Network Function Virtualization and Slicing techniques. The capability of each of 6G services is provided by its control and management functions and service specific data process functions.

In addition to support 6G XaaS services at the service layer 310, 6G system leverages 5G System for provisioning of vertical services. The difference between 6G XaaS services and other verticals are that a vertical is a pure customer which needs other XaaS services to enable its operation, while each of XaaS services provide their capabilities to 6G customers.

Any pair of XaaS services of the 6G system could also be mutual customer and provider of each other. Some of examples are that an infrastructure owner provides its resource to XaaS services in service layer 310 and C/M layer 320; RM services may need the capabilities provided by NET4AI 311, DAM 313, and NET4DW 315 for its resource management for vertical slicing; CONET 325 service and NET4Data 312 service may need the capability provided by NET4BC 314 for their operation.

Key concepts of 6G system may include the following aspects.

Define Basic XaaS Services by decoupling comprehensive types of services into basic XaaS services. A basic XaaS service provides unique capability to enable a specific type of service, such as NET4AI 311 service, NET4DW 315 service, DAM 313 service, NET4Data 312 service, Block chain 314 service, mission management 322 service, etc.

Allow joint operation of the 6G system by multiple partners.

Define data plane of the 6G system which includes processing functions of data plane of XaaS services. Programing the interconnection of these functions, by mission management service, enables to support a variety of customized customer services.

Simplify 6G system architecture by categorizing basic control services and management services and combining them as basic XaaS services in C/M layer 320.

Define C/M Plane of the 6G system which includes C/M functions in XaaS services and may include 5G control plane (e.g., an authentication management function (AMF)) depending on implementation options.

Define Basic Architecture Structure (BAS) which is a unified basic structure with minimized number of interfaces and is independent of types of infrastructures.

Simplify standardization, development and deployment of the 6G system using the BAS concept, while supporting a variety of infrastructure deployment scenarios.

Adapt to a variety of deployment scenarios by applying the BAS or a subset of it to infrastructures based on capability, capacity and requirement of the infrastructure networks.

Leverage service-based interface (SBI) concept and apply SBI interaction in both 6G C/M plane and 6G data plane.

Simplify SBI interfaces by introducing trustworthy (TW) gateways (GWs) in data plane and C/M plane of the 6G system.

Improve trustworthiness from perspectives of operation of the 6G system by introducing CONET capability, NET4BC capability and anonymous service provisioning provided by the trustworthy GWs in the C/M plane and data plane of the 6G system.

Improve trustworthiness from perspective of end customer privacy protection by unified mutual authentication, IDM, data sanitization and etc. provided by SPM 323 service, DAM 313 service, and 6G block chain service.

Simplify roaming management of wireless devices, in physical world and digital world, by unified authentication including all participated partners and customers.

Support multiple development paths from 5G system to 6G system by defining multiple architecture options without incurring much efforts due to the introduction of the BAS concept.

Support backward compatibility by utilizing benefits of SBA and its add-on feature. 5G users can use the 6G system to access 5G services.

Support future extension by adding new XaaS services with minimized impact on standardization and deployment, due to the introduced anonymous service provisioning concept implemented in trustworthy GWs in 6G C/M plane and in 6G data plane.

Under the scope of increasing societal digitization, a universal and ultra-high-performance Information and Communication Technology (ICT) infrastructure is considered as an important foundation to support demands from individual users, as well as from so-called vertical industries. 3G networks attempted to capture the Internet market by providing certain services, but limited these to the technological domain of telecommunication operators, hence largely failing to attract the Internet players. 4G networks corrected this through an efficient implementation of high-speed IP packet delivery, opening up the service space. 5G networks provided a successful beginning for integrating new types of network usage and new user communities, and provided a beginning for industry use cases and players. The philosophy underlying 5G development might be roughly summarized through connecting more and different types of users better. However, for the users, service-level properties are important and 5G as a connecting network or access network cannot fully control these. This identifies a gap between the aspirations of 5G and the actual technical specification.

The 6G network might be characterized by a high degree of heterogeneity in terms of participating players, which includes not only conventional telecommunications operators, but also new relevant players such as vertical operators. Ecosystem Openness of future networks is relevant from technology aspect as well as from social and commercial aspects. Furthermore, a trustworthy and secure interactions among the players should be provided in the multi-player ecosystem, and the data flowing and usage among the players raises the concern on security and privacy protection. The 6G network should have native support for privacy protection.

Future networks may also be expected to play more and more important role in future society and become an attractive industry. A more open business environment and eco-system regarding development, deployment, operation, control and management of wireless network can be expected. A variety of players in this industry will play different roles. Exclusively control and management of wireless networks by operators is facing huge challenges. Embodiments of the present disclosure may provide or support CONET which may provide confederation services for multiple parties (players) to address these challenges effectively.

Embodiments of the present disclosure provide methods, apparatuses, computer readable storage medium, computer program product for managing overhead for multiple players. In the present solution, a first function (such as an SCF) determines parameters for uploading action logs to the blockchain, and thus the parameters can be used by the XaaS entity for uploading the action logs. The parameters include a first set of interval parameters and a second set of grouping parameters, this allows for the uploading of action logs to be done accordingly, avoiding individual uploads for each action log and reducing overhead. Therefore, a management of overhead for multi players in the system is enabled, and the system can be scalable and credible for multiple players to work together, allowing for dynamically enabling or delivering unknown future services without modifying or redesigning the system architecture. Principles and implementations of the present disclosure will be described in detail below with reference to the figures.

6G network will continue playing the crucial role in entire society. In contrast to the conventional method, such as exclusive control and management of wireless networks by telecom operators, an open and trustful business environment and an ecosystem including infrastructure deployment, operation, control and management of wireless systems are expected. A variety of players in this ecosystem will play different roles. Exclusively control and management of wireless networks by operators is facing huge challenges. CONET provides an architecture and a complete set of solutions to address these challenges effectively. The CONET comprises CONET Controller and CONET Agent(s). The CONET Controller includes CCF (Confederation Control Function) and SCF (Surveillance Control Function).

The CCF may be in charge of the following: Establish confederation; Allow members leave and join; Retrieve Confederation profile; Trigger upload to chain; Authentication and Authorization; and Interact with control plane Gateway. The SCF may be in charge of the following: Deploy and manage CONET agents; Action Surveillance; and Support lawful query.

From a system design perspective, a proper number of players may be needed to be defined. It's not appropriate to provide a flexible ecosystem, regardless of the number of players being big or small. If the player granularity is too small and the number of players is too large, the network will be too complex and the system efficiency will be too low. Therefore, the selection of a proper granularity to define the player is a key issue. In the Architecture of CONET, players work as modules of N4AI, N4DATA, DAM etc., and each module includes one CONET Agent, one TCF (Task control function) and many PFs (Processing function).

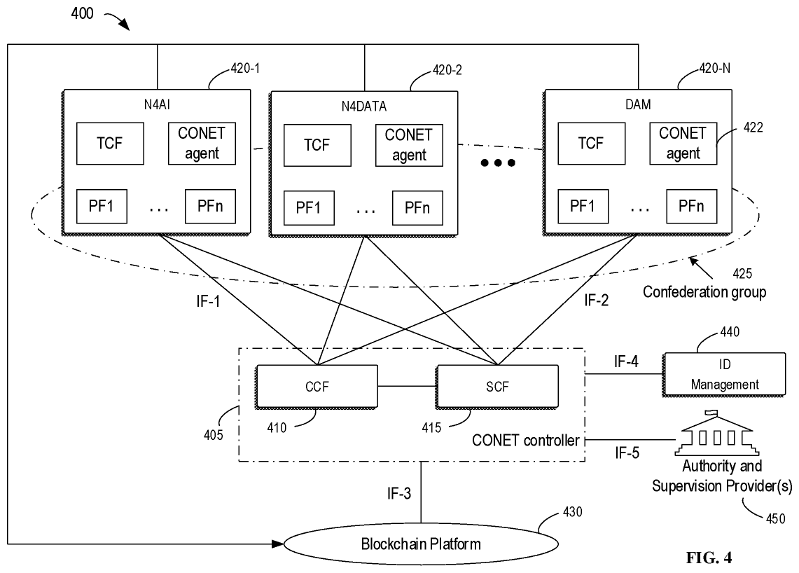

FIG. 4 illustrates an example CONET architecture 400 in which some example embodiments of the present disclosure may be implemented. As shown in FIG. 4, multiple service modules 420-1 through 420-N (generically referred to as modules 420) which may form a confederation group 425. As illustrated in FIG. 4 the CONET architecture 400 includes a CONET controller 405 and one or more CONET agents 422. The CONET controller 405 includes a confederation control function (CCF) 410 and a surveillance control function (SCF) 415. The CCF 410 and the SCF 415 may be operatively coupled together and may be implemented using the same or different networked computing hardware, such as servers, dedicated electronics, virtualized computing resources, etc. The one or more CONET agents 420 are similarly operatively coupled to the SCF 415 and may be implemented using networked computing hardware, for example hardware which is integrated with or operatively coupled to the 420 modules 420 within which the agents 422 are respectively integrated.

By way of non-limiting example, the modules 420 may include a network for artificial intelligence (N4AI) module 420-1, a network for data (N4DATA) module 420-2, . . . , and a data analytics and management (DAM) module 420-N. These examples are not necessarily intended to be limiting.

Each of the modules 420 may provide a different respective role in the service. This role may be provided as a sub-service in accordance with the XaaS model. Each of the modules 420 may include a task control function (TCF) for managing provision of the sub-service and a plurality of processing functions (PFs) for provision of the sub-service. An entity (e.g. a PF) as used herein may refer to an instantiation of a module or function. For example, a DAM02 entity may be an instantiation of a DAM module 420-N. At an operation stage, an entity generates transactions and uploads action records to a blockchain, e.g. via NET4BC.

At a development or deployment stage, the modules 420 operate together as partners to join the confederation group 425 and provide a confederation chain profile. A confederation chain profile, in the context of the modules 420 and also more generally, may specify information such as a module topology and performance requirements in relation to a blockchain.

Accordingly, in various embodiments, a system in a computer network is provided. The system includes a plurality of network functions established using networked computing resources and operatively coupled together. These network functions include the CCF 410, the SCF 415, and the agents 422. The CCF 410 is configured to establish and manage a confederation involving a plurality of modules 420. The confederation may provide a service via cooperation of the modules 420. The agents 422 are each integrated into a different respective one of the plurality of modules 420. Each agent 422 may be configured to generate and provide (e.g. to the SCF 415) a record of actions taken by said respective one of the plurality of modules 420. The SCF 415 is configured to deploy and communicate with the agents 422. The SCF 415 is also configured to perform surveillance of actions taken by the modules 420, for example based at least in part on the records of actions provided by the agents 422. Agents 422 may operate as interface between their host module 420, within which they are deployed, and the controller 405. At an operation stage, the agents 422 are configured to collect action records of their host modules 420 and send surveillance reports to the controller 405.

The controller 405 may include a shared C/M layer to support XaaS services working together in a trusted environment. At a development/deployment stage the controller 405 facilitates modules 420 to join the confederation group 425, and notifies the blockchain (e.g. at NET4BC) with profile information to initialize a corresponding blockchain. At an operation stage, the controller 405 receives upload/surveillance action of upload/data update requests from entities (modules) and notifies the blockchain.

In more detail, the CCF 410 may be configured to perform operations such as: establishing the confederation, allowing modules to leave or join the confederation, retrieving a confederation profile, triggering uploads to blockchain, managing authentication and/or authorization of modules, and interacting with control plane gateways. A group profile of a confederation group 425 may indicate, for example a group ID and a member ID for the confederation group 425. This may involve message passing between the CCF 410 and the modules 420, the CCF 410 retrieving information from the modules 420 and sending queries or commands to the modules 420, performing logging, authentication and verification steps, and the like.

Also in more detail, the SCF 415 may be configured to perform operations such as: deploying (e.g. instantiating and configuring) and managing the agents 422, performing surveillance (e.g. monitoring and logging) of the modules 420, and supporting lawful queries, such as requests for information made by authorities or regulatory agencies.

The CCF 410 interacts with the modules 420 via a network interface indicated as IF-1. The SCF 415 interacts with the modules 420, agents 422, or both, via a network interface IF-2. The CCF 410 interacts with a blockchain platform 430 via a network interface IF-3. For example, the CCF 410 may interact via IF-3 with the blockchain platform 430 in order to trigger the platform to provide services, for example by establishing a blockchain according to a confederation group request, and triggering the blockchain to perform logging operations, action uploads, etc. The CCF 410 may thus direct a blockchain platform 430 (also referred to as a blockchain service) to establish a blockchain to support the service, and to direct the modules 420 to utilize the blockchain for providing the service. Subsequent utilizing of the blockchain by the modules 420 may include posting log records to the blockchain, posting action requests to the blockchain, or the like, or a combination thereof. At a deployment stage, the blockchain platform 430 (e.g. NET4BC) initializes a blockchain according to a given chain profile. At an operation stage, the blockchain platform 430 receives information such as transmission uploads or surveillance actions, generates blocks, verifies blocks and stores blocks. The blocks may be stored using NET4Data, for example.

The CCF 410 interacts with an ID management entity 440 via a network interface IF-4. The ID management entity 440 may be an authorization and authentication server, for example, which authenticates devices for example via cryptographic certificates, and provides authorization services, as would be readily understood by a worker skilled in the art. The interaction via IF-4 may support the CCF's action of authentication and/or authorization of the modules 420. Thus, the CCF 410 may be configured to perform or trigger authentication and/or authorization of each of the modules 420, in cooperation with the ID management entity 440, and to admit each of the modules 420 to the confederation group 425 only after successful completion of said authentication and/or authorization.

The SCF 415 may interact with one or more authority and supervision providers (ASPs) 450 via IF-5. The ASPs 450 may be or represent legal authorities, regulatory agencies, or the like. The ASPs 450 may monitor activities of the modules 420 or end users via reports from the SCF 415. The ASPs 450 may be required to comply with certain regulations or laws prior to such monitoring. Thus, the SCF 415 may be configured to receive and respond to queries from government or regulatory authority agencies, at least in part by providing information obtained by the SCF 415 to said government or regulatory authority agencies, upon determining that it is lawful to do so.

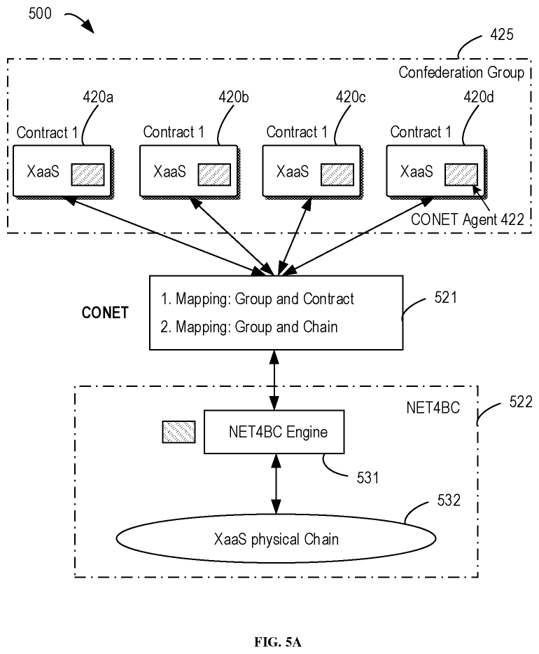

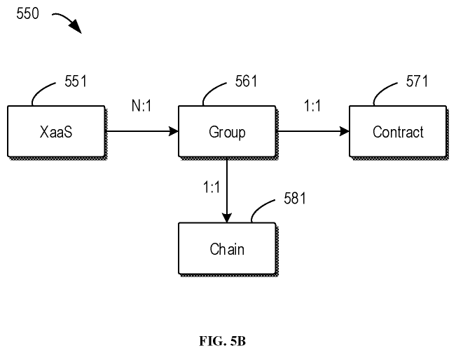

FIG. 5A illustrates an example framework 500 of elements related to CONET in accordance with some example embodiments of the present disclosure. The framework 500 illustrates a CONET at XaaS level design. Multiple service modules 420a, 420b, 420c, 420d (generically referred to as 420), each provides an XaaS service, may form a confederation group 425. In addition, each of the multiple service modules 420 may include a CONET agent, such as the CONET agent 422 as shown in FIG. 5A.

The CONET controller 405 as shown in FIG. 4 may include a CONET module 521 which operates at the XaaS level and a NETBC engine 531 which operates at the NETBC level. The blockchain platform 430 as shown in FIG. 4 may include an XaaS physical chain 532.

The CONET module 521 may provide its functionality as a service to other XaaS modules, such as but not necessarily limited to the multiple service modules 420a-420d. In such a scenario, the CONET module 521 operates at the XaaS level. Each player registers to the CONET module 521, and the CONET module 521 performs mapping of a group and a contract and mapping of a group and a chain. After these procedures, players (e.g. the above-mentioned modules) work together in the same group or confederation to perform defined actions.

The NET4BC module 522 may provide a NETBC service. As shown in FIG. 5A, the NET4BC module 522 includes a NET4BC engine 531 and an XaaS physical chain 532. The NETBC engine 531 provides generic management and control of block chain operations. The NET4BC engine 531 handles block data and enables block chain as a service. The NET4BC engine 531 may be configured to initialize blockchains, generate blockchain blocks (records), verify blockchain blocks, and store blockchain blocks on the XaaS physical chain 532. Blockchain operation can proceed in a variety of ways as will be readily understood by a worker skilled in the art, to provide a (e.g. public) record of transactions, actions or events.

In FIG. 5B, a framework 550 of main elements related to CONET include an XaaS service 551, a group 561, a contract 571 (also refer to a group contract), and a chain 581. In some embodiments, each XaaS service, such as DAM, NET4AI, or NET4DATA, works as a member to join a group and requests requirement to the CONET module 521. The CONET module 521 aggregates different XaaS services into a same group.

In the present disclosure, a group may be called as a confederation group, a CONET group, etc., and a group includes multiple XaaS services. Each XaaS service in a group may be called as an XaaS service consumer, and may be regarded as a member or a player of a group, in other words, a group may include multiple members or multiple players.

A group is associated with a contract that defines the role and behaviors of each of the different XaaS services. Different groups may correspond to different contracts. A group may consist of the minimum number of XaaS services that can implement functions to reduce redundancy. The CONET module 521 employs blockchain to ensure trustworthiness for each XaaS service in a group. The CONET module 521 performs the mapping operation between group and blockchain according to requirement from XaaS services and are on blockchain. The NET4BC engine 531 receives requirement and initials a blockchain for a group.

In some embodiments, an XaaS service is identified by an XaaS service ID and a group is identified by a group ID. Multiple XaaS service IDs may be associated with one group ID, since multiple XaaS services (the quantity may be N, as shown in FIG. 5B, the value of N is greater than 1.) form a group. A group contract is identified by a contract ID and a contract defines the role and behaviors of each member in the corresponding group. Therefore, a group ID corresponds to a contract ID.

An XaaS service may be described using an XaaS service profile, e.g., profile information of the XaaS service. The XaaS service profile (profile information of the XaaS service) may include one or more of: a service name of the XaaS service, a service ID of the XaaS service, one or more entity names of one or more entities which the XaaS service comprises, one or more entity IDs of the one or more entities, entity information of the one or more entities (including one or more entity locations of the one or more entities), deployment information associated with at least one valid entity in the one or more entities, role information of each of the one or more entities, an action list for each of the one or more entities, or a requirement of the XaaS service. In some embodiments, details of the XaaS service profile (profile information of the XaaS service) may refer to Table 1 below.

TABLE 1
XaaS service profile

| Name | Description |
|---|---|
| XaaS | This information indicates the name of XaaS service. |
| service name | |
| XaaS | This information identifies the XaaS service. |
| service ID | |
| Entity name | This information indicates the name of the entity. |
| Entity ID | This information identifies the entity contained in the |
| | XaaS service. |
| Entity | This information indicates where the entity is valid. |
| location | |
| Deployment | This information describes where each entity is valid to |
| profile | indicate C/M-TW-GW and MM to generate BAS topology |
| | profile and MM policy table respectively. |
| Role profile | This information describes the roles of each entity to |
| | indicate C/M-TW-GW to generate authorization profile and |
| | MM policy table respectively. |
| Action | This information describes the action list of each entity. |
| list profile | |
| Requirement | This information describes the service requirements of |
| from XaaS | XaaS for CONET. |
| service | |

In some examples, the XaaS service name may indicate the name of XaaS service, such as NET4AI, DAM, NET4DATA, or NET4BC. In some examples, the XaaS service ID may be used to identify the XaaS service, e.g., the XaaS service ID may be NET4AI ID, DAM ID, NET4DATA ID, or NET4BC ID. In some embodiments, an XaaS service may include one or more entities, for example, the NET4AI includes entities of AI encoder, AI classifier, and AI evaluator. In some examples, the entity name may include one or more entity names of the one or more entities. In some examples, the entity ID may be used to identify the entity(ies) included in the XaaS service. For example, if the XaaS service name is NET4AI, the entity ID may include AI encoder ID, AI classifier ID, and AI evaluator ID. In some examples, the entity location may indicate where the entity/entities is/are valid (e.g. deployed), for example, the CONET module 521 may choose suitable entity (or entities) based on the entity location. In some examples, the deployment profile may be used to describe where each entity is valid to indicate to C/M-TW-GW and MM to generate a BAS topology profile and MM policy table respectively. In some examples, the role profile may be used to describe the roles of each entity to indicate to C/M-TW-GW to generate authorization profile and MM policy table respectively. In some examples, the action list profile may be used to describe the action list of each entity. In some examples, the requirement from XaaS service may be used to describe the service requirements of XaaS for CONET. For example, if the XaaS service name is DAM, the requirement from XaaS service may indicate throughput and delay of DAM proceeding for CONET. In some instances, the requirement from XaaS service in the XaaS service profile may be replaced by XaaS request service, and the present disclosure does not limit.

A group may be described using a group profile, e.g., group information. The group information (group profile) may include one or more of: a group name, a group ID, a list of members which the group comprises, or a list of member IDs of the members. In some embodiments, details of the group profile (group information) may refer to Table 2 below.

TABLE 2
group profile

| Name | Description |
|---|---|
| Group name | This information indicates the name of group. |
| Group ID | This information identifies the group. |
| Group member | This information describes each member in a group. |
| Group member ID | This information identifies the group member. |

In some examples, the group name may indicate the name of the group, for example, the naming may show a purpose of the group. In some examples, the group ID may be used to identify the group, for example, each member in the group may have (or be associated with, correspond with) the group ID. For example, multiple members in the group may share the same group ID. In some examples, the group member may be used to describe each member in the group. In some examples, the group member ID may be used to identify the member(s) in the group. For example, if the group includes an XaaS service, then the group member ID may include (or be the same as) the XaaS service ID of the XaaS service. For example, if the group includes an entity, then the group member ID may include (or be the same as) the entity ID of the entity.

A contract (or group contract) may be described using a contract profile, e.g., contract information. The contract information (contract profile) may include one or more of: a contract name, a contract ID, or contract content. In some embodiments, details of the contract profile (contract information) may refer to Table 3 below.

TABLE 3
contract profile

| Name | Description |
|---|---|
| Contract name | This information indicates the name of contract. |
| Contract ID | This information identifies the contract. |
| Contract | This information describes the content of contract, i.e. |
| content | the rules for each member to follow in a group. |

In some examples, the contract name may indicate the name of the contract, for example, the naming rule for the contract may follow the name of the group, e.g. a purpose of the group. For example, a group for charging may correspond to a contract, and the contract may be named as “charging”. In some examples, the contract ID may be used to identify the contract, and it is understood that a contract ID corresponds to a group ID. In some examples, the contract content may be used to describe the content of the contract, for example, the content may indicate rules for each member in the group to follow.

A chain may be described using a chain profile, e.g., chain information. The chain profile (chain information) may include one or more of: a chain name, a chain ID, a list of blockchain requirements, a list of blockchain performances, or a list of upload methods. In some embodiments, details of the chain profile (chain information) may refer to Table 4 below.

TABLE 4
chain profile

| Name | Description |
|---|---|
| Chain | This information indicates the name of blockchain. |
| name | |
| Chain ID | This information identifies the blockchain. |
| Chain | This information describes blockchain requirement from the |
| requirement | entity to NET4BC, i.e. topology, data type, security level, |
| | performance requirement. |
| Chain | This information describes blockchain performance |
| performance | feedbacked by NET4BC. |
| Upload | This information indicates to entity methods to upload to |
| methods | blockchain, i.e., the full content, the abstract of the content, |
| | and the URL of blockchain. |

In some examples, the chain name may indicate the name of blockchain. Each entity has its own action(s). For example, an entity DAM has actions of Data collection, Data pre-processing, and Data sanitization, while another entity NET4AI has actions of AI encoder, AI classifier and AI evaluator. In some examples, the chain ID may be used to identify the blockchain, each chain ID may correspond to one group ID. In some examples, the chain requirement may be used to describe blockchain requirement(s) from the entity to NET4BC. For example, a topology (examples of which may include distributed or centralized) indicates the structure and type of the blockchain, a security level indicates the read/write permission, and a performance requirement (also refers to a performance request or a requirement) indicates throughput and delay of the blockchain. In some examples, the upload methods may be used to indicate to entity methods to upload to the blockchain, i.e. the full content, the abstract of the content, and a uniform resource locator (URL) of the blockchain. In other words, the upload methods may provide methods for entities uploading to the blockchain.

An action surveillance may be described using an action surveillance profile, e.g., action surveillance information. The action surveillance profile (action surveillance information) may include one or more of: an action name, an action ID, a security level, action features, or an interaction method. In some embodiments, details of the action surveillance profile (action surveillance information) may refer to Table 5 below.

TABLE 5
action surveillance profile

| Name | Description |
|---|---|
| Action name | This information indicates the name of action. |
| Action ID | This information identifies the action. |
| Security | This information identifies action security level, i.e., |
| level | green level, yellow level, and red level. |
| Action features | This information describes action features of each entity. |
| Interaction | This information indicates interaction methods between |
| method | CONET and entity, i.e., synchronous method and |
| | asynchronous method. |

In some examples, the action name may indicate the name of the action. Each entity has its own action. For example, an entity DAM is with actions of Data collection, Data pre-processing, and Data sanitization, while another entity NET4AI is with actions of AI encoder, AI classifier and AI evaluator. In some examples, the action ID may be used to identify the action of each entity. For example, an entity DAM is with actions of Data collection ID, Data pre-processing ID, and Data sanitization ID. For example, an entity NET4AI is with actions of AI encoder ID, AI classifier ID, and AI evaluator ID. In some examples, the security level may be used to identify an action security level. For example, green level is used for Common data and Request/response/notification/configure message. Yellow level is used for entity important data. Red level is used for ID information, security key data and entity private data. In some examples, the action feature(s) may be used to describe action feature of each entity. For example, the action features of an entity DAM are timestamp, data representation, and sanitization method. For example, the action features of an entity NET4AI are ReceiveFrontPropagation, ContinueFrontPropagation, ReceiveBackPropagation, and ContinueBackPropagation. In some examples, the interaction method may be used to indicate interaction methods between CONET and entity. For example, a difference between a synchronous method (also refers to a synchronous message process) and an asynchronous method (also refers to an asynchronous message process) includes message queue for caching.

As described above, the SCF 415 may perform an action surveillance. In some embodiments, action surveillance information may be used for describing mapping between actions and entities. For example, the action surveillance information may be represented by an action surveillance table. The action surveillance table keeps mapping record between actions and entities. An XaaS entity may include one or multiple actions, for example, each entity ID may correspond to one or multiple action IDs.

The action surveillance information (e.g. action surveillance table) may be generated based on the action surveillance profile. In some examples, the XaaS service profile, the group profile, the contract profile, and the chain profile may also be used for generating the action surveillance information (e.g. action surveillance table). The action surveillance information (e.g. action surveillance table) may include multiple entries, each entry comprises multiple fields. For example, the multiple fields include a security level, action feature(s) and an interaction method. In some embodiments, details of the action surveillance table may refer to Table 6 below.

TABLE 6
action surveillance table

| | | | | | | |
|---|---|---|---|---|---|---|
| service | DAM | DAM | NET4AI | NET4AI | NET4DATA | NET4DATA |
| Service | S00101 | S00101 | S00102 | S00102 | S00103 | S00103 |
| ID | | | | | | |
| Group ID | G001 | G001 | G001 | G001 | G001 | G001 |
| Contract | C00020 | C00020 | C00020 | C00020 | C00020 | C00020 |
| ID | | | | | | |
| Entity ID | DAM001 | DAM001 | NET4AI001 | NET4AI001 | NET4DATA002 | NET4DATA005 |
| Action | Data | Data | AI encoder | AI | Ingress/ | Ingress/ |
| ID | collection | sanitization | ID | classifier | egress GW | egress GW |
| | ID; Data | ID | | ID; AI | ID; | ID; |
| | pre- | | | evaluator | | |
| | processing | | | ID | | |
| | ID | | | | | |
| Security | Yellow | Red | Green | Green | Yellow | Yellow |
| level | | | | | | |
| Action | {timestamp, | {timestamp, | {ReceiveFrontPropagation; | {ReceiveFrontPropagation; | {Upload | {Download |
| feature | data | data | ContinueFrontPropagation; | providepredication; | metadata} | metadata} |
| | source, data | representation, | ReceiveBackPropagation; | ReceivelossFunctionValue; | | |
| | representation} | sanitization | ContinueBackPropagation; | StartBackPropagation;} | | |
| | {timestamp, | method} | | {ReceivePredication; | | |
| | data | | | ReceiveLableProviderLossFunc- | | |
| | representation, | | | tionValue} | | |
| | pre- | | | | | |
| | processing | | | | | |
| | method} | | | | | |
| Interaction | asynchronous | asynchronous | synchronous | synchronous | asynchronous | asynchronous |
| method | | | | | | |

The action surveillance table may keep mapping records between actions and entities, the fields (rows in Table 6) in the action surveillance table are some non-limited examples. In some embodiments, the action surveillance table in Table 6 is only for illustration without any limitations. In some examples, more rows (of fields) may be further included, such as group name, contract name, chain name, group member, contract content, etc. In some examples, one or more rows may be omitted, such as contract ID. Details of each row in the action surveillance table may refer to that discussed above with reference to Tables 1-5.

It is to be understood that the format of the action surveillance table in Table 6 is only for illustration without any limitation, for example, the column and the row can be interchanged, for example, a row may be used to indicate an entry of the table, while a column is used for indicate a field of the table, details of which will not be repeated.

An XaaS entity includes one or more actions, for example, the XaaS entity may provide a service by performing one or more actions. Corresponding action log(s) may be generated, and the action log(s) may be data associated with an action while being performed. In some implementations, the action log(s) may include some or all of the following: an action ID, an entity ID which performs the action, an XaaS service ID of the XaaS service, a timestamp of the action, a type of the action, input data type of the action, output data type of the action, input data volume of the action, output data volume of the action, a starting time of the action, an ending time of the action, a time duration of the action, etc. It should be understood that the action log(s) provided here is/are only for illustration without any limitation, some other information may also be included in the action log(s), the present disclosure does not limit.

The action log(s) may be recorded by a network function (NF) of the XaaS service/entity. For example, the NF may record and store the action log(s) while the action is performed. The action log(s) may be uploaded to the blockchain, e.g. to a chain on the blockchain. Specifically, in some embodiments of the present disclosure, the NF may provide the action log(s) to a CONET agent which is associated with the XaaS entity/service, and then the CONET agent may further upload the action log(s) to the chain.

For the multiple players in the system, each player may include multiple XaaS entities. Therefore, there may be an amount of action logs from the multiple players to be uploaded to the blockchain, in this case, the overhead for uploading the action logs should be reduced to improve the system performance. In this event, the present disclosure provides a solution to manage overhead for multiple players in the system.

For action overhead management in the present disclosure, multiple parameters may be defined, specifically, the SCF 415 may configure (or determine, or set) the parameters. In the present disclosure, two methods including a grouping method and a silence method can be used to reduce the overhead. For each identified “CONET surveillance action”, it is needed to determine the consideration of overhead minimization. Specifically, one method, such as the grouping method or the silence method may be determined for each identified “CONET surveillance action”.

For an action of an XaaS service, the SCF 415 may perform an action surveillance, in this event, an action may also be referred to as a CONET surveillance action. For an action, corresponding action logs may be generated and are to be uploaded to the blockchain, under the action surveillance of the SCF 415. A method such as the grouping method or the silence method may be used while uploading the action logs to the blockchain.

The grouping method defines to combine same type logs into one notification to reduce the number of messages. Grouping parameters are defined as grouping_by to avoid waiting for a long time if SCF 415 does not have enough logs. In some embodiments, if two or more action logs have a same type, they can be grouped (or combined) into a same group. The two or more action logs in a same group can be uploaded in a same message or a same notification. As such, the number of messages or notifications can be reduced, and thus the overhead can be reduced. In some embodiments, one or more parameters for grouping (represented as grouping_by) may be used for the grouping method.

The silence method defines to check whether the received log(s) meet the silent configuration. If yes, the SCF 415 does not send log uplink to chain. In some embodiments, the silent configuration may be defined, and may be used for determining whether to use the silence method. In some examples, there may be multiple action logs each having same information, and the silence configuration may indicate that only one or several of the multiple same action logs are needed to be uploaded. In this case, other action logs may not be uploaded. As such, the amount of action logs being uploaded can be reduced, and thus the overhead can be reduced.

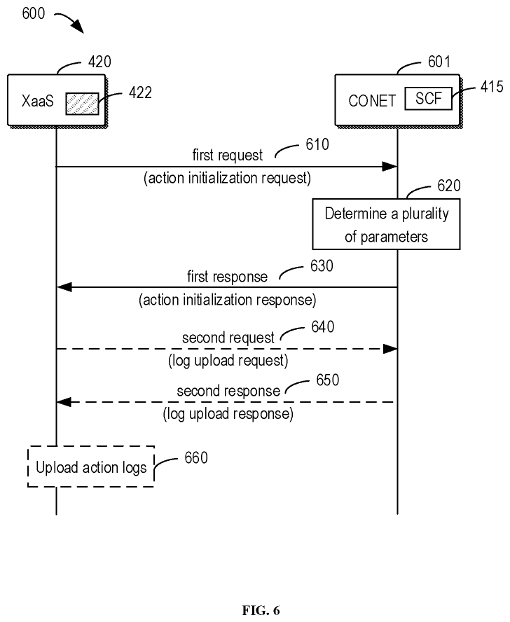

In the present disclosure, for each method (the grouping method or the silence method), different management methods may be applied, that is, the SCF 415 may employ different management methods for each method. Details of the management methods can refer to embodiments below with reference to FIG. 6.

Reference is now made to FIG. 6, which illustrates an example process 600 in accordance with some embodiments of the present disclosure. The process 600 involves an XaaS service module 420 and a CONET service module 601, where the XaaS service module 420 may provide an XaaS service which includes one or more XaaS entities. In some embodiments, the XaaS service module 420 may include a CONET agent 422, the CONET service module 601 includes an SCF 415, and the process 600 may involve the CONET agent 422 and the SCF 415. For example, the CONET agent 422 may be a module or a function of the XaaS service module 420. The SCF 415 can be referred to as a first function, and the CONET agent 422 can be referred to as a second function.

In the process 600, the CONET agent 422 transmits a first request to the SCF 415 at 610. The first request is used for an initialization for uploading action logs to a blockchain. For example, the first request may be an action initialization request message. In some example embodiments, when the CONET agent 422 receives an action initialization request message from an NF, it may transmit the first request. Optionally, in response to receiving the action initialization request message from an NF, the CONET agent 422 forwards the action initialization request message (as the first request) to the SCF 415.

In some examples, the first request or the action initialization request message may include information related to the action logs. For example, the information may include some or all of the following: an entity ID of the XaaS entity, an action type, data amount, etc. It is to be noted that more or less information may be included in the first request or the action initialization request message, and the present disclosure does not limit this aspect.

The SCF 415 determines a plurality of parameters for the initialization based on the first request at 620. Specifically, the information included in the first request may be used for determining the plurality of parameters. The plurality of parameters may be used by the NF and/or the CONET agent 422. In some embodiments, the plurality of parameters may include parameters used by the NF and parameters used by the CONET agent 422.

In some implementations, the SCF 415 may further determine at least one parameter used by the SCF 415. The SCF 415 may store (or keep) the at least one parameter at the SCF 415. In the present disclosure, the parameters determined by the SCF 415 include the plurality of parameters used by the NF and/or the CONET agent 422, and optionally further include the at least one parameter used by the SCF 415. In some example embodiments, the parameters determined by the SCF 415 may include a first set and a second set. The first set of parameters may be a first set of interval parameters, and the second set of parameters may be a second set of grouping parameters. This allows for the uploading of action logs to be done accordingly, avoiding individual uploads for each action log and reducing overhead.

In the present disclosure, a pull or push mode may be used for data transfer between two different modules. For example, the NF may provide data to the CONET agent 422 in a push mode. For example, the CONET agent 422 may obtain data from the NF in a pull mode, and may provide data to the SCF 415 and/or the chain in a push mode. For example, the SCF 415 may provide data to the chain in a push mode. In the present disclosure, the term “pull” may also be interchangeably used with one of: send, transmit, provide, or the like, and the term “push” may be interchangeably used with one of: receive, obtain, acquire, capture, or the like, the present disclosure does not limit.

The parameters determined by the SCF 415 may include a first interval. The first interval is represented as NF_interval, which may be used for the NF to push action logs to the CONET agent 422. Specifically, the NF should send the action logs to the CONET agent 422 according to the first interval. For example, a time gap between two adjacent transmissions of action logs from the NF to the CONET agent 422 should be not less than the first interval.

The parameters determined by the SCF 415 may include a second interval. The second interval is represented as scrape_interval, which may be used for the CONET agent 422 to pull action logs from the NF. Specifically, the CONET agent 422 should capture action logs from the NF according to the second interval. For example, for the CONET agent 422, a time gap between two adjacent receptions of action logs from the NF should be not less than the second interval.

The parameters determined by the SCF 415 may include a third interval. The third interval is represented as agent_interval, which may be used for the CONET agent 422 to push action logs to the SCF 415 or to the blockchain. In some examples, the CONET agent 422 should send the action logs to the blockchain according to the third interval.

The parameters determined by the SCF 415 may include a timeout interval. The timeout interval is represented as scrape_timeout, which may be used by the CONET agent 422 to stop pulling action logs from the NF. As an example, the CONET agent 422 should stop pulling action logs in case the timeout interval is reached.

The parameters determined by the SCF 415 may include a repeat interval. The repeat interval is represented as repeat_interval, which may be used for retransmission of action logs to the blockchain. In some instances, if a first transmission (push) of action logs is failed, a second transmission (i.e. a retransmission of the first transmission) may be performed according to the repeat interval. For example, a maximum retransmission number may be configured. For example, a time gap between the second transmission and the first transmission should be not less than the repeat interval.

The parameters determined by the SCF 415 may include a surveillance interval. The surveillance interval is represented as surveillance_interval, which is used for the SCF 415 to perform action surveillance. In some instances, the SCF 415 may trigger the uploading of the action logs according to the surveillance interval.

The parameters determined by the SCF 415 may include a first grouping interval and a second grouping interval. The first group interval is represented as grouping_interval, which may be used for defining a smallest interval of two groups with a same type. The second group interval is represented as grouping_wait, which may be used for defining a longest interval of two action logs in a same group. As an example, a group may include multiple action logs, and timestamps of the multiple action logs in the same group should be within a time range not larger than the second group interval (grouping_wait). As an example, if a group has been generated and sent, the next group with the same group type should be generated after a time gap not less than the first grouping interval (grouping_interval).

The parameters determined by the SCF 415 may include one or more parameters for grouping. The one or more parameters for grouping can be represented as grouping_by, which may be used for determining which action logs can be grouped.

In the present disclosure, the parameters determined by the SCF 415 may also be called as message management parameters. In some implementations, the parameters may include three types, a first type of parameters includes NF_interval, scrape_interval, agent_interval, and surveillance_interval; a second type of parameters includes scrape_timeout and repeat_interval; and a third type of parameters includes grouping_by, grouping_wait, and grouping_interval.

In some implementations, the parameters may include a plurality of parameters to be transmitted to the CONET agent 422 and at least one parameter to be used by the SCF 415.

In some other implementations, the parameters may include three parts, a first part of parameters include parameter(s) to be used by the NF, a second part of parameters include parameter(s) to be used by the CONET agent 422, and a third part of parameters include parameter(s) to be used by the SCF 415. The plurality of parameters to be transmitted to the CONET agent 422 may include the first part of parameters to be used by the NF and the second part of parameters to be used by the CONET agent 422. The at least one parameter to be used by the SCF 415 may include the third part of parameters to be used by the SCF 415. In some implementations, the at least one parameter to be used by the SCF 415 (i.e. the third part of parameters) may be stored at the SCF 415.

In the process 600, the SCF 415 transmits a first response to the CONET agent 422 at 630, and the first response includes the plurality of parameters. In other words, the SCF 415 may transmit to the CONET agent 422 the parameters to be used by the NF and the CONET agent 422.

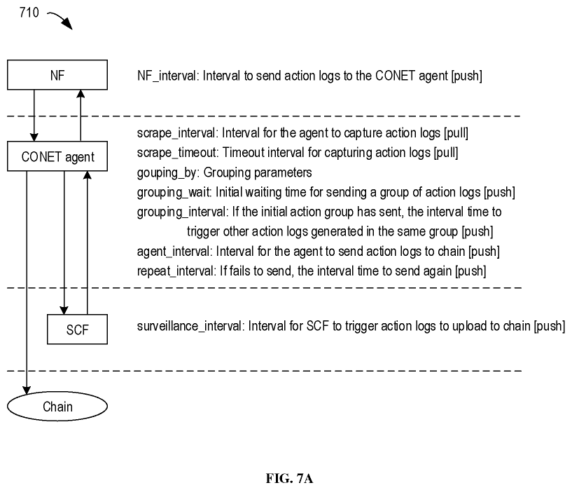

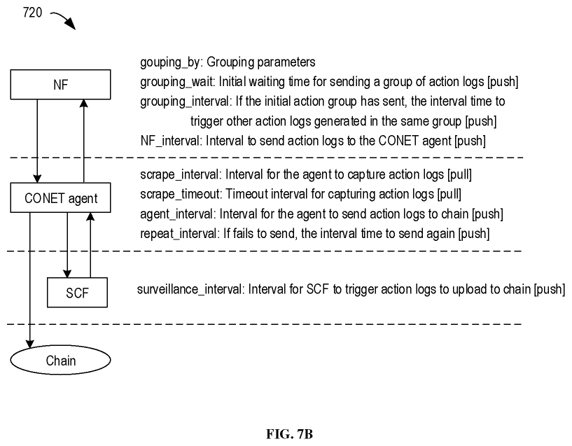

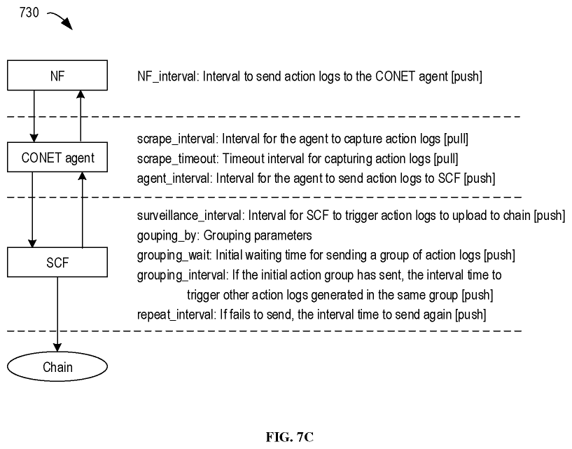

Reference is now made to FIGS. 7A-7C. FIG. 7A illustrates an example 710 of parameters, and FIG. 7B illustrates another example 720 of parameters. In the example 710 or 720, the plurality of parameters included in the first response may include some or all of the following: NF_interval, scrape_interval, agent_interval, scrape_timeout, repeat_interval, grouping_by, grouping_wait, and grouping_interval. In the example 710 or 720, the at least one parameter that stored at the SCF 415 includes surveillance_interval.

FIG. 7C illustrates a further example 730 of parameters, in the example 730, the plurality of parameters included in the first response may include: NF_interval, scrape_interval, agent_interval, and scrape_timeout. In the example 730, the at least one parameter that stored at the SCF 415 includes: surveillance_interval, grouping_by, grouping_wait, grouping_interval, and repeat_interval. In the example 730, the NF pushes data to the CONET agent with NF_interval. The CONET agent uses scrape_interval and scrape_timeout to pull data from the NF, and pushes data to the SCF. The SCF pushes data to the chain with parameters such as surveillance_interval, grouping_by, grouping_wait, grouping_interval, and repeat_interval. The term “data” here may refer to the action logs in some embodiments of the present disclosure.

In addition, in response to receiving the first response from the SCF 415, the CONET agent 422 may store the plurality of parameters. In some implementations, the CONET agent 422 can provide the parameters to be used by the NF to the NF. In the example 710 as shown in FIG. 7A, NF_interval may be provided to the NF. In the example 720 as shown in FIG. 7B, NF_interval, grouping_by, grouping_wait, and grouping_interval may be provided to the NF.

In addition, the CONET agent 422 may keep (or store) the parameters to be used by the CONET agent 422, e.g. scrape_interval, agent_interval, scrape_timeout, grouping_by, grouping_wait, grouping_interval, and repeat_interval in FIG. 7A. The NF may keep (or store) the parameters to be used by the NF, e.g. NF_interval in FIG. 7A.

It is to be understood that the parameters determined by the SCF 415 discussed above are only for illustration without any limitation, for example, some parameter may be modified or omitted, some other parameter may be added, or some parameters may be combined, the present disclosure does not limit.

In some example embodiments, the SCF 415 may further determine a management mode, and transmit an indication of the management mode to the CONET agent 422. The management mode is also called as a message management mode, which may be one of: on-demand mode, periodical mode, threshold mode, and poll based mode.

The on-demand mode is applied for a pull operation. In case there is a need for the action logs, the pull operation may be performed. For example, the CONET agent 422 may determine to pull action logs from the NF according to its demand.

The periodicity mode is applied for both the pull and push operations. In case a periodicity is defined, the pull and push operations may be performed within the periodicity, and will not be performed out the periodicity. For example, a first periodicity may be defined or configured for the NF, and the NF can push the action logs to the CONET agent 422 in the first periodicity. For example, a second periodicity and a third periodicity may be defined or configured for the CONET agent 422, and the CONET agent 422 can pull action logs from the NF in the second periodicity and push the action logs to the chain in the third periodicity. In some instances, the first periodicity, the second periodicity, and the third periodicity may be the same or may be different.

The threshold mode is applied for both the pull and push operations. In case a threshold is defined, the pull and push operations may be performed when the threshold is reached. For example, if an amount of action logs at the NF reaches a first threshold, the NF may push the action logs to the CONET agent 422. For example, if an amount of action logs at the CONET agent 422 reaches a second threshold, the CONET agent 422 may push the action logs to the chain. For example, if an amount of action logs at the CONET agent 422 is less than a third threshold, the CONET agent 422 may pull action logs from the NF. In some instances, the third threshold is smaller than the second threshold.

The poll based mode is applied for both the pull and push operations. In case a query is defined, the pull and push operations may be performed when a query is received. For example, if the NF receives a query from the CONET agent 422 and there are some action logs to be pushed, then the action logs at the NF can be pushed to the CONET agent 422. For example, if the CONET agent 422 receives a query from the NF, then the CONET agent 422 can pull the action logs from the NF.

It is to be noted that the pull and push operations should be performed based on both the management mode if configured and the parameters discussed above. In some implementations, the indication of the management mode may be transmitted in the first response, or may be transmitted in a separate message. For example, the indication of the management mode may be transmitted before 610, the present disclosure does not limit. In some example embodiments, the CONET agent 422 may provide the management mode to the NF. In some example embodiments, each of the NF and the CONET agent 422 may store (or keep) the management mode.

In some example embodiments, the SCF 415 may further determine an interaction method for uploading, and transmit an indication of the interaction method to the CONET agent 422. The interaction method is also called as a message transfer message. The interaction method may be a synchronous method (or is called as a synchronous message transfer message) or an asynchronous method (or is called as an asynchronous message transfer message). In case the synchronous method is applied, the action logs should be uploaded to the chain, e.g., by using the management mode and the parameters. In case the asynchronous method is applied, the action logs should be cached for a time period, and then be uploaded to the chain. In some implementations, the indication of the interaction method may be transmitted in the first response, or may be transmitted in a separate message. For example, the indication of the interaction method may be transmitted before 610, the present disclosure does not limit. In some example embodiments, the CONET agent 422 may store (or keep) the interaction method.

In some implementations, the information in the first request may be used by the SCF 415 to determine some or all of the following: the plurality of parameters, the at least one parameter, the management mode, and the interaction method. However, it is to be noted that some other information may be considered, such as the XaaS service, the XaaS entity, or the like, the present disclosure does not limit.

The example process 600 including 610-630 discussed above may be regarded as an action initialization process. In some implementations, the action initialization process may be performed before an uploading process of action logs, for example, the action initialization process may be used for determining or configuring the parameters to manage overhead.

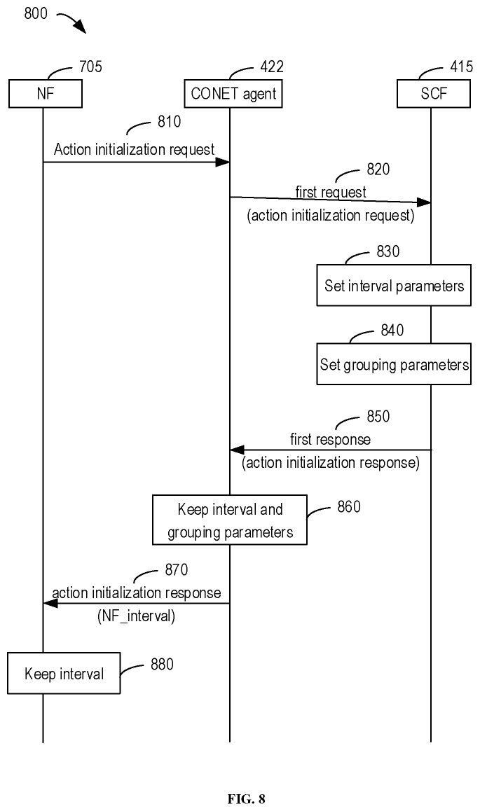

FIG. 8 illustrates an example action initialization process 800 in accordance with some embodiments of the present disclosure. The process 800 may involve an NF 705, a CONET agent 422, and an SCF 415. For example, the NF 705 and the CONET agent 422 may be associated with an XaaS entity or an XaaS service.

In the process 800, the NF 705 sends an action initialization request message to the CONET agent 422 at 810, the action initialization request message at 810 is used to request action initialization. The CONET agent 422 receives the action initialization request message from the NF 705 at 810 and may further transfer a first request to the SCF 415 at 820. The first request may be the action initialization request message. For example, in response to receiving the action initialization request message from the NF 705, the CONET agent 422 may forward the message to the SCF 415.

The SCF 415 sets interval parameters at 830. The interval parameters may include intervals such as NF_interval, scrape_interval, agent_interval, surveillance_interval, to reduce overhead described with reference to FIGS. 6-7C. The SCF sets grouping parameters at 840. The grouping parameters may include parameters such as grouping_by, grouping_wait, grouping_interval described with reference to FIGS. 6-7C.

The SCF 415 sends a first response to the CONET agent 422 at 850. The first response may be an action initialization response message. Specifically, the SCF 415 responses the action initialization response to the CONET agent 422. In addition, the CONET agent 422 keeps intervals and grouping parameters at 860.

The CONET agent 422 further send an action initialization response message to the NF 705 at 870. For example, the action initialization response message to the NF 705 may include an interval parameter to be used by the NF 705. That is, the CONET agent 422 makes a response to the NF 705 with interval(s). Accordingly, the NF 705 keeps the interval(s) at 880.

It is to be noted that some details of the operations in process 800 may refer to those discussed with reference to FIGS. 6-7C, and thus will not be redundantly repeated herein for brevity.

It is to be noted that the process 800 in FIG. 8 is an example illustration without any limitation. In some embodiments, the process 800 may be modified to obtain another process, for example, in case the example 720 is used, the grouping parameters may be provided to the NF 705. In some embodiments, some operation in the process 800 may be omitted or modified, some operations in the process 800 may be combined, some further operation(s) may be further added, or an order of some operations may be changed, the present disclosure does not limit.

Reference is made back to FIG. 6, the CONET agent 422 transmits a second request to the SCF 415 at 640, and the second request is used for requesting uploading action logs. For example, the second request may be an action log upload request. The SCF 415 transmits a second response to the CONET agent 422 at 650, and the second response may include blockchain information for uploading. For example, the second response may be an action log upload response. For example, the blockchain information includes location information (such as URL) of a chain on the blockchain. That is, the SCF 415 may respond with the location information of the chain. In addition, the CONET agent 422 uploads the action logs to the chain at 660. For example, the parameters, the management mode, and the interaction method are considered while uploading.

In some embodiments, if the example 710 is applied, the CONET agent 422 may determine whether the grouping rules or the silent configuration is met. If the silent configuration is met, the action logs will not be uploaded to the chain. If the grouping rules are met, the CONET agent 422 may generated one or more groups of action logs based on the second set of grouping parameters. The CONET agent 422 may further upload the one or more groups of action logs to the chain based on the first set of interval parameters, if the interaction method is a synchronous method. Otherwise, the CONET agent 422 may cache the one or more groups of action logs for a time period and then upload the one or more groups of action logs to the chain based on the first set of interval parameters, if the interaction method is an asynchronous method.

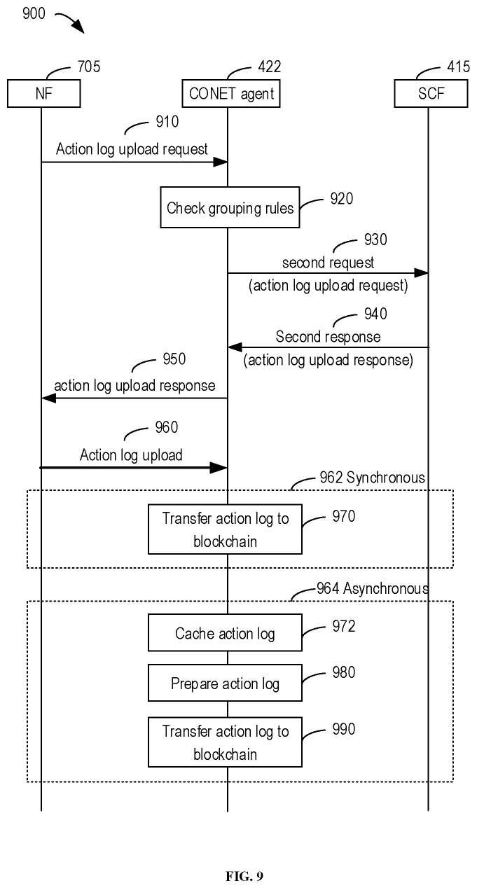

FIG. 9 illustrates an example process 900 for uploading in accordance with some embodiments of the present disclosure. The process 900 may involve an NF 705, a CONET agent 422, and an SCF 415. For example, the NF 705 and the CONET agent 422 may be associated with an XaaS entity or an XaaS service. Specifically, the process 900 is based on an assumption that the example 710 in FIG. 7A is applied.

In the process 900, the NF 705 sends an action log upload request to the CONET agent 422 at 910, the action log upload request at 910 is used to request to upload log (i.e. action logs), and the action log upload request may also be called as a log upload request or an upload request message. The CONET agent 422 receives the action log upload request at 910, and then checks grouping rules at 920. Specifically, the CONET agent 422 can check the grouping rules to decide whether to make grouping. For example, the CONET agent 422 can determine to use a grouping method or a silent method.

The CONET agent 422 sends a second request to the SCF 415 at 930. The second request may be an action log upload request. For example, in response to receiving the action log upload request from the NF 705, the CONET agent 422 may forward the action log upload request to the SCF 415.

The SCF 415 sends a second response to the CONET agent 422 at 940. The second response may be an action log upload response. For example, in response to the received action log upload request from the CONET agent 422, the SCF 415 responses to the CONET agent with the second response. The second response include blockchain information, such as an internet protocol (IP) address or a URL of the chain on the blockchain. That is, the SCF 415 may respond to the CONET Agent 422 with the blockchain information.

The CONET agent 422 sends an action log upload response to the NF 705 at 950. For example, in response to receiving the second response from the SCF 415, the CONET agent 422 transfers the action log upload response to the NF 705. Accordingly, the NF 705 can upload its action logs to the CONET agent 422 at 960. For example, a configured management mode and the parameter NF_interval may be used by the NF 705 to push the action logs to the CONET agent 422.

In addition, the CONET agent 422 may upload the action logs to the chain. If a synchronous method is configured or indicated, Block 962 will be performed, in this case, the process 900 may be a synchronous message process. If an asynchronous method is configured or indicated, Block 964 will be performed, in this case, the process 900 may be an asynchronous message process.

In Block 962, the CONET agent 422 transfers the action logs to the blockchain at 970. The CONET agent 422 may pull action logs from the NF 705 based on the scrape_interval, and generate one or more groups of action logs based on grouping_by, grouping_wait, and grouping_interval. In addition, the CONET agent 422 uploads the one or more groups to the chain based on the agent_interval, and optionally repeat_interval. For example, the one or more groups will be upload to the chain with the location information indicated by the second response.

In Block 964, i.e. the asynchronous method is used, the CONET agent 422 caches action logs at 972. In some examples, at least one queue may be used for caching the action logs. The CONET agent 422 may prepare the action logs for uploading at 980, for example, the grouping method or the silence method may be used for preparing. In addition, the CONET agent 422 transfers the action logs to the blockchain at 990. For example, the CONET agent 422 may generate one or more groups of action logs based on grouping_by, grouping_wait, and grouping_interval; and uploads the one or more groups to the chain based on the agent_interval, and optionally repeat_interval. For example, the one or more groups will be uploaded to the chain with the location information indicated by the second response.

In this way, action logs can be combined into a group based on the grouping parameters and be uploaded based on the interval parameters, avoiding individual uploads for each action log and reducing overhead.

In some embodiments, the transfer at 970 or 990 may be performed when a transfer condition is met. In some examples, the transfer condition is determined based on the management mode or the parameters. For example, the management mode is a threshold mode, the transfer condition may include that an amount of action logs in a group reaches a threshold. For example, the transfer condition may include that the parameter grouping_wait for a group is met. It should be noted that the transfer condition may be some other conditions, such as a time related condition, etc., the present disclosure does not limit.

It is to be noted that the process 900 is only for illustration without any limitation. In some implementations, some operations may be combined or reordered. In some embodiments, the operation 920 may be performed before 970 in Block 962. In some embodiments, the operation 920 may be combined into 980 in Block 964. For example, for a newly received (or pulled from the NF 705) action log, if the newly received action log is the same as a previous action log, a silence method may be used, in this case, the newly received action log will not be uploaded to the chain. For example, for a newly received (or pulled from the NF 705) action log, if the newly received action log has a same type with one or more previous action logs in a group, the newly received action log will be combined into the group, which will be uploaded to the chain.

Although the process 900 is described with reference to example 710 in FIG. 7A, the present disclosure does not limit this aspect. In some implementations, if example 720 is applied, the NF 705 may check grouping rules to determine whether to use the grouping method or the silence method, and the NF 705 may generate a group including multiple action logs with a same type in case the grouping method is used; or the NF 705 may not push the action log to the CONET agent 422 in case the silence method is used. In some implementations, if example 730 is applied, the CONET agent 422 may push action logs to the SCF 415, and the SCF 415 may perform further operations. For example, the further operations by the SCF 415 may include: checking grouping rules to determine whether to use the grouping method or the silence method; generating a group including multiple action logs with a same type in case the grouping method is used; or stopping uploading the action log to the chain in case the silence method is used.

It is to be understood that the process 900 may be modified to obtain another process, for example, some operation(s) in the process 900 may be omitted, modified, combined, or some further operation(s) may be further added, the present disclosure does not limit.

It is to be appreciated that although the process 800 and the process 900 may be implemented separately, in some cases, the process 900 may be combined with the process 800. For example, the process 800 may be regarded as an action initialization process, and the process 900 may be performed after the process 800. For example, some operations in the process 800 and other operations in the process 900 may be combined.

It is to be appreciated that current wireless systems, such as 5G systems, are designed to provide only connected services and are managed and operated by a single party or participant (i.e., network operators). It is expected that future wireless systems, such as 6G systems, will go beyond connectivity provision to provide a variety of new services such as artificial intelligence as a service, data management as a service, and more. It is also expected that future wireless systems may be operated by multiple players, part of each participant's operating system, providing certain services for internal use of the system or end customer use. Therefore, it is desirable to design an open system architecture for future wireless systems that is capable of providing any service and can be centered on any player character to support various operating scenarios. The system is expected to be scalable, allowing for dynamically enabling or delivering unknown future services without modifying or redesigning the system architecture. The procedures may include the action initialization process and the synchronous/asynchronous message transfer process, which supports complicated processing logic and extensibility, and is openness.

According to some embodiments of the present disclosure with reference to FIGS. 4-9, methods, apparatuses, computer readable storage medium, computer program product for action surveillance in CONET for multiple players are provided. In the present solution, an SCF may determine parameters for uploading action logs to the blockchain. The parameters may be configured to reduce overhead, which will be used while uploading the action logs to the blockchain by an XaaS entity, and thus the action surveillance is enabled. As such, the CONET can provide a method to manage overhead for multi players in the system. Therefore, the system can be scalable and credible for multiple players to work together.

According to the present disclosure, a solution of action surveillance in CONET for multiple players is provided, which can reduce overhead when uploading action logs. An action surveillance table is designed to handle mapping record between actions and NFs, for example, XaaS service profile, group profile, and action surveillance profile are designed for facilitate the action surveillance table.

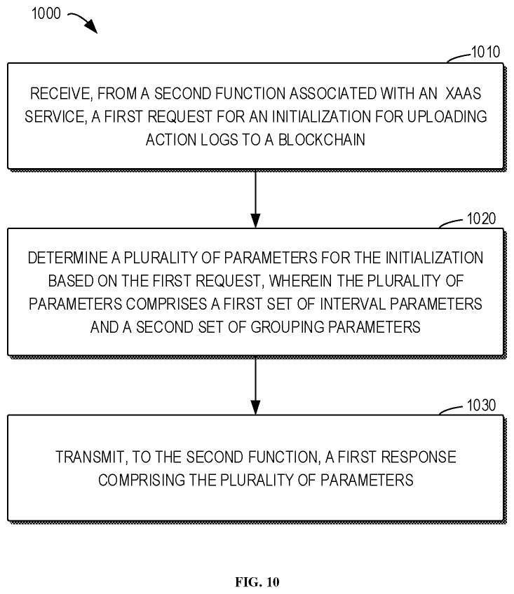

FIG. 10 illustrates a flowchart of an example method 1000 implemented at a first function in accordance with some embodiments of the present disclosure. For the purpose of discussion, the first function which may perform the method 1000 can be the SCF 415 discussed above.

At block 1010, the first function receives, from a second function associated with an XaaS service, a first request for an initialization for uploading action logs to a blockchain. At block 1020, the first function determines a plurality of parameters for the initialization based on the first request, wherein the plurality of parameters may comprise a first set of interval parameters and a second set of grouping parameters. At block 1030, the first function transmits, to the second function, a first response comprising the plurality of parameters.

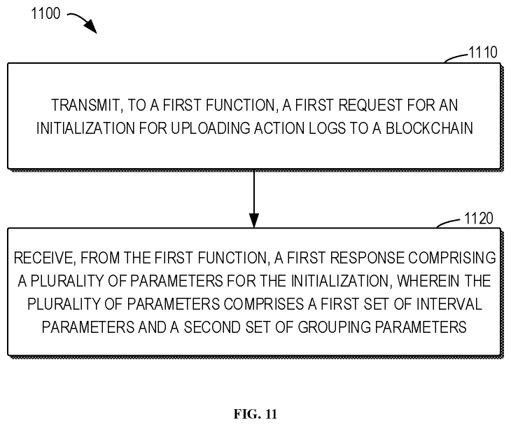

FIG. 11 illustrates a flowchart of an example method 1100 implemented at a second function in accordance with some embodiments of the present disclosure. For the purpose of discussion, the second function which may perform the method 1100 can be the CONET agent 422 of an XaaS service 420 discussed above, for example, the second function may be a CONET agent associated with an XaaS entity.

At block 1110, the second function transmits, to a first function, a first request for an initialization for uploading action logs to a blockchain. At block 1120, the second function receives, from the first function, a first response comprising a plurality of parameters for the initialization, wherein the plurality of parameters may comprise a first set of interval parameters and a second set of grouping parameters.

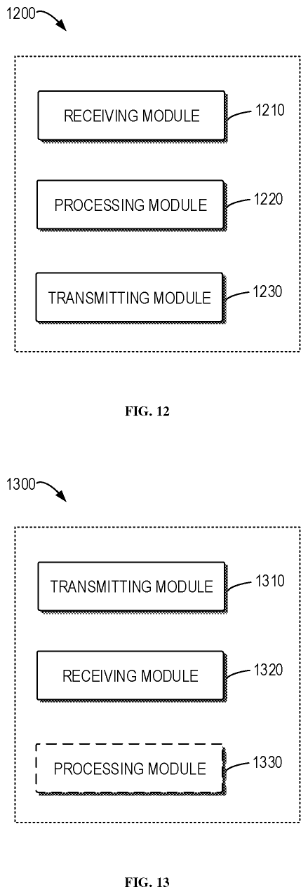

FIG. 12 illustrates a simplified block diagram of an apparatus 1200 according to some example embodiments of the present disclosure. The apparatus 1200 may be implemented as a device or a chip in the device, and the scope of the present application is not limited in this respect. The apparatus 1200 may include multiple modules for performing corresponding processes in the method 1000 as discussed in FIG. 10 and related operation performed by the SCF 415 discussed with reference to FIGS. 6-9. The apparatus 1200 may be implemented as the first function (such as the SCF 415 as shown in FIG. 4) or a part of the first function. As illustrated in FIG. 12, the apparatus 1200 comprises a receiving module 1210, a processing module 1220, and a transmitting module 1230. In some embodiments, the receiving module 1210 and the transmitting module 1230 may be implemented as a transceiver.

In some implementations, the receiving module 1210 is configured to receive, from a second function associated with an XaaS service, a first request for an initialization for uploading action logs to a blockchain. In some implementations, the processing module 1220 is configured to determine a plurality of parameters for the initialization based on the first request, wherein the plurality of parameters may comprise a first set of interval parameters and a second set of grouping parameters. In some implementations, the transmitting module 1230 is configured to transmit, to the second function, a first response comprising the plurality of parameters.

In some embodiments, the first set of interval parameters comprises at least one of: a first interval for a network function of the XaaS service to push the action logs to the second function, a second interval for the second function to pull the action logs from the network function, or a third interval for the second function to upload the action logs to the blockchain. In some embodiments, the first set of interval parameters further comprises at least one of: a timeout interval for the second function pulling action logs from the network function, or a repeat interval for uploading. In some embodiments, the second set of grouping parameters comprises at least one of: a first grouping interval for a smallest interval of any two logs in a same group, a second grouping interval for a longest interval of any two logs in a same group, or one or more parameters for grouping.

In some embodiments, the processing module 1220 is configured to determine at least one parameter used by the first function, wherein the at least one parameter comprises a surveillance interval for triggering of uploading the action logs.

In some embodiments, the processing module 1220 is configured to determine a management mode for the initialization; and the transmitting module 1230 is configured to transmit, to the second function, an indication of the management mode, wherein the management mode comprises one of: an on-demand mode, a periodical mode, a threshold mode, or a poll based mode.

In some embodiments, the processing module 1220 is configured to determine an interaction method for the action logs; and the transmitting module 1230 is configured to transmit, to the second function, an indication of the interaction method, wherein the interaction method comprises a synchronous method or an asynchronous method.

In some embodiments, the receiving module 1210 is configured to receive, from the second function, a second request for uploading the action logs. In some embodiments, the transmitting module 1230 is configured to transmit, to the second function, a second response comprising location information of a chain on the blockchain.

The apparatus 1200 can be used to implement some embodiments at the SCF 415 described with reference to FIGS. 4-11.

FIG. 13 illustrates a simplified block diagram of an apparatus 1300 according to some example embodiments of the present disclosure. The apparatus 1300 may be implemented as a device or a chip in the device, and the scope of the present application is not limited in this respect. The apparatus 1300 may include multiple modules for performing corresponding processes in the method 1100 as discussed in FIG. 11 and related operation performed by the CONET agent 422 discussed with reference to FIGS. 6-9. The apparatus 1300 may be implemented as the second function (such as the CONET agent 422 of an XaaS module 420 as shown in FIG. 4) or a part of the second function. As illustrated in FIG. 13, the apparatus 1300 comprises a transmitting module 1310, a receiving module 1320, and a processing module 1330. In some embodiments, the receiving module 1320 and the transmitting module 1310 may be implemented as a transceiver.

In some implementations, the transmitting module 1310 is configured to transmit, to a first apparatus (such as the SCF 415), a first request for an initialization for uploading action logs to a blockchain. In some implementations, the receiving module 1320 is configured to receive, from the first function, a first response comprising a plurality of parameters for the initialization, wherein the plurality of parameters comprises a first set of interval parameters and a second set of grouping parameters.

In some embodiments, the first set of interval parameters comprises at least one of: a first interval for a network function of the XaaS service to push the action logs to the second function, a second interval for the second function to pull the action logs from the network function, or a third interval for the second function to upload the action logs to the blockchain. In some embodiments, the first set of interval parameters further comprises at least one of: a timeout interval for the second function pulling action logs from the network function, or a repeat interval for uploading. In some embodiments, the second set of grouping parameters comprises at least one of: a first grouping interval for a smallest interval of any two logs in a same group, a second grouping interval for a longest interval of any two logs in a same group, or one or more parameters for grouping.

In some embodiments, the receiving module 1320 is configured to receive, from the first function, an indication of a management mode for the initialization, wherein the management mode comprises one of: an on-demand mode, a periodical mode, a threshold mode, or a poll based mode.

In some embodiments, the receiving module 1320 is configured to receive, from the first function, an indication of an interaction method for the action logs, wherein the interaction method comprises a synchronous method or an asynchronous method.

In some implementations, the transmitting module 1310 is configured to transmit, to the first function, a second request for uploading the action logs. In some embodiments, the receiving module 1320 is configured to receive, from the first function, a second response comprising location information of a chain on the blockchain.

In some embodiments, the apparatus 1300 further includes a processing module 1330. In some implementations, the processing module 1330 is configured to: determine a group of action logs based on the second set of grouping parameters; and upload the group of action logs to the chain on the blockchain based on the first set of interval parameters.

In some implementations, the processing module 1330 is configured to: in accordance with a determination that an interaction method is an asynchronous method, cache the action logs at the second function; and in accordance with a transfer condition is met, transmit the at least one group of action logs to the blockchain.

The apparatus 1300 can be used to implement some embodiments at the CONET agent 422 associated with an XaaS entity in an XaaS module 420 described with reference to FIGS. 4-11.

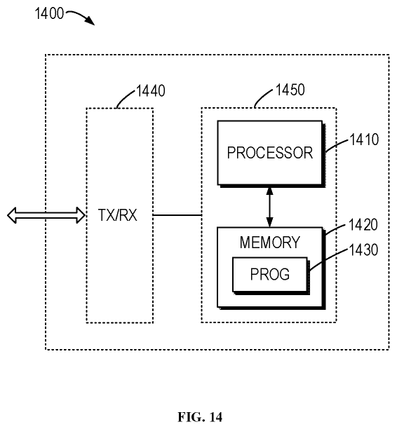

FIG. 14 illustrates an example block diagram of a device 1400 that may be used to implement some embodiments of the present disclosure. The device 1400 can be considered as a further example implementation (e.g., part) of the first function and the second function as discussed above, e.g., the SCF 415 or the CONET agent 422 associated with an XaaS entity/service.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications.

The program 1430 is assumed to include program instructions that, when executed by the associated processor 1410, enable the device 1400 to operate in accordance with the embodiments of the present disclosure, as discussed herein with reference to FIGS. 1-13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The present disclosure provides a device or an apparatus, comprising: a processor; and a memory storing computer program codes; the memory and the computer program codes configured to, with the processor, cause the device or the apparatus to perform the method implemented at the first function or the second function discussed above.

The present disclosure provides a computer readable medium having instructions stored thereon, the instructions, when executed by a processor of an apparatus, causing the apparatus to perform the method implemented at the first function or the second function discussed above.

The present disclosure provides a computer program product comprising instructions, the instructions, when executed by a processor of an apparatus, causing the apparatus to perform the method implemented at the first function or the second function discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-n. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method performed by a first function, the method comprising:
receiving, from a second function associated with an anything as a service (XaaS) service, a first request for an initialization for uploading action logs to a blockchain;
determining a plurality of parameters for the initialization based on the first request, wherein the plurality of parameters comprise a first set of interval parameters and a second set of grouping parameters; and
transmitting, to the second function, a first response comprising the plurality of parameters.

2. The method of claim 1, wherein the first set of interval parameters comprises at least one of:
a first interval for a network function of the XaaS service to push the action logs to the second function,
a second interval for the second function to pull the action logs from the network function, or
a third interval for the second function to upload the action logs to the blockchain.

3. The method of claim 2, wherein the first set of interval parameters further comprises at least one of:
a timeout interval for the second function pulling action logs from the network function, or
a repeat interval for uploading.

4. The method of claim 1, wherein the second set of grouping parameters comprises at least one of:
a first grouping interval for a smallest interval of any two logs in a same group,
a second grouping interval for a longest interval of any two logs in a same group, or
one or more parameters for grouping.

5. The method of claim 1, further comprising:
determining at least one parameter used by the first function, wherein the at least one parameter comprises a surveillance interval for triggering uploading the action logs.

6. The method of claim 1, further comprising:
determining a management mode for the initialization; and
transmitting, to the second function, an indication of the management mode, wherein the management mode comprises one of:
an on-demand mode,
a periodical mode,
a threshold mode, or
a poll based mode.

7. The method of claim 1, further comprising:
determining an interaction method for the action logs; and
transmitting, to the second function, an indication of the interaction method, wherein the interaction method comprises a synchronous method or an asynchronous method.

8. The method of claim 1, further comprising:
receiving, from the second function, a second request for uploading the action logs; and
transmitting, to the second function, a second response comprising location information of a chain on the blockchain.

9. A method performed by a second function, the method comprising:
transmitting, to a first function, a first request for an initialization for uploading action logs to a blockchain; and
receiving, from the first function, a first response comprising a plurality of parameters for the initialization, wherein the plurality of parameters comprise a first set of interval parameters and a second set of grouping parameters, and wherein the second function is associated with an anything as a service (XaaS) service.

10. The method of claim 9, wherein the first set of interval parameters comprises at least one of:
a first interval for a network function of the XaaS service to push the action logs to the second function,
a second interval for the second function to pull the action logs from the network function, or
a third interval for the second function to upload the action logs to the blockchain.

11. The method of claim 10, wherein the first set of interval parameters further comprises at least one of:
a timeout interval for the second function pulling action logs from the network function, or
a repeat interval for uploading.

12. The method of claim 9, wherein the second set of grouping parameters comprises at least one of:
a first grouping interval for a smallest interval of any two logs in a same group,
a second grouping interval for a longest interval of any two logs in a same group, or
one or more parameters for grouping.

13. The method of claim 9, further comprising:
receiving, from the first function, an indication of a management mode for the initialization, wherein the management mode comprises one of:
an on-demand mode,
a periodical mode,
a threshold mode, or
a poll based mode.

14. The method of claim 9, further comprising:
receiving, from the first function, an indication of an interaction method for the action logs, wherein the interaction method comprises a synchronous method or an asynchronous method.

15. The method of claim 9, further comprising:
transmitting, to the first function, a second request for uploading the action logs; and
receiving, from the first function, a second response comprising location information of a chain on the blockchain.

16. The method of claim 15, further comprising:
determining a group of action logs based on the second set of grouping parameters; and
uploading the group of action logs to the chain on the blockchain based on the first set of interval parameters.

17. The method of claim 15, further comprising:
in accordance with a determination that an interaction method is an asynchronous method, caching the action logs at the second function; and
in accordance with a transfer condition is met, transmitting at least one group of action logs to the blockchain.

18. A communication system, comprising:
a first function; and
a second function associated with an anything as a service (XaaS) service;
wherein the first function is configured to:
receive, from the second function, a first request for an initialization for uploading action logs to a blockchain;
determine a plurality of parameters for the initialization based on the first request, wherein the plurality of parameters comprise a first set of interval parameters and a second set of grouping parameters; and
transmit, to the second function, a first response comprising the plurality of parameters; and
wherein the second function is configured to:
transmit, to the first function, the first request for an initialization for uploading action logs to a blockchain; and
receive, from the first function, the first response comprising the plurality of parameters for the initialization.

19. The communication system of claim 18, wherein the first set of interval parameters comprises at least one of:
a first interval for a network function of the XaaS service to push the action logs to the second function,
a second interval for the second function to pull the action logs from the network function, or
a third interval for the second function to upload the action logs to the blockchain.

20. The communication system of claim 18, wherein the second set of grouping parameters comprises at least one of:
a first grouping interval for a smallest interval of any two logs in a same group,
a second grouping interval for a longest interval of any two logs in a same group, or
one or more parameters for grouping.
